(19) United States
(12) Patent Application Publication
(10) Pub. No.: US 2003/0083087 A1
(43) Pub. Date: May 1, 2003

(54) Systems and methods for implementing calls using pre-established multicast groups in a multicast IP network

(76) Inventors: Randy L. Ekl, Lake Zurich, IL (US); Michael F. Korus, Hoffman Estates, IL (US)

Correspondence Address: MOTOROLA, INC., 1303 EAST ALGONQUIN ROAD, IL01/3RD, SCHAUMBURG, IL, 60196

(21) Appl. No.: 10/012,823

(22) Filed: Oct. 30, 2001

(51) Int. Cl. H04B 7/00

(52) U.S. Cl. 455/518; 455/445

(57) ABSTRACT

Systems and methods for implementing dispatch and/or point-to-point calls using pre-established multicast groups are disclosed. The methods include setting up and semi-permanently maintaining pre-established multicast group(s) in advance of prospective call(s), and utilizing the semi-permanent multicast groups when certain call requests are received to reduce call set up time and system loading. A zone controller identifies groups of endpoints that are expected to collectively participate in prospective call(s). The zone controller causes pre-established multicast groups to be established between the endpoints by distributing respective multicast group addresses to the endpoints in advance of prospective call(s). The endpoints, which may include adjacent sites, issue Join commands to associated network devices causing the network devices to establish a multicast routing tree for the multicast group. Later, upon a call request being received for a particular call, the zone controller identifies participating endpoints for the call. If the participating endpoints are members of a pre-established multicast group, the zone controller may cause payload for the call to be addressed to the multicast group address of the pre-established multicast group so that it may be distributed via the already-established multicast routing tree. If the participating endpoints are not members of a pre-established multicast group, the zone controller may establish a multicast group for the duration of the call.

### FIELD OF THE INVENTION

This invention relates generally to communication systems, and particularly communication systems incorporating multicast internet protocol (IP) addressing.

### BACKGROUND OF THE INVENTION

Communication systems typically include a plurality of communication devices, such as mobile or portable radio units (sometimes called “subscribers”), dispatch consoles, call loggers and base stations (sometimes called base site repeaters) that are geographically distributed among various base sites and infrastructure sites. The radio units wirelessly communicate with the base stations and each other using radio frequency (RF) communication resources, and are often logically divided into various subgroups or talkgroups. Communication systems are often organized as trunked systems, where the RF communication resources are allocated on a call-by-call basis among multiple users or groups. Large communication systems are sometimes organized into a plurality of “zones,” wherein each zone includes multiple sites and a central controller or server (“zone controller”) for allocating communication resources among the multiple sites.

Next generation communication systems have begun to use Internet Protocol (IP) multicasting techniques to transport packet data representative of voice, video, data or control traffic between endpoints (or “hosts” in IP terminology). In such systems, the endpoints, including base stations, consoles, call loggers, zone controllers, and in some instances, wireless mobile or portable radio units in different zones that desire to receive packets for a particular call, send Internet Group Management Protocol (IGMP) Join messages to their attached routers, causing the routers of the network to create a spanning tree of router interfaces for distributing packets for the call. Upon completion of the call, the endpoints send Internet Group Management Protocol (IGMP) Leave messages to tear down the tree. Presently, there are two fundamental types of IP multicast routing protocols, commonly referred to as sparse mode and dense mode. Generally, in sparse mode, the spanning tree of router interfaces is pre-configured to branch only to endpoints having joined the multicast address; whereas dense mode employs a “flood-and-prune” operation whereby the spanning tree initially branches to all endpoints of the network and then is scaled back (or pruned) to eliminate unnecessary paths.

A problem that arises in IP multicast communication systems, most particularly in large systems comprising several sites and/or zones, is that the number of Joins and Prunes is so large that the time and/or the amount of traffic generated by the selected multicast routing protocol to establish the spanning tree may adversely affect call set-up times or voice quality as each site competes for limited site bandwidth. It would be desirable to reduce call set up times by pre-establishing certain semi-permanent multicast groups between selected endpoints before prospective calls occur. In such manner, the pre-established multicast spanning tree may be maintained semi-permanently and used for the prospective call or calls, when they occur, while reducing or eliminating the need for additional Joins or Prunes at call set up time. Advantageously, the endpoints of the pre-established multicast groups will be selected according to known, likely traffic configurations. For example, it is contemplated that pre-established multicast groups will be desired between geographically adjacent sites, as there is a high probability that calls will almost continuously occur between adjacent sites. The present invention is directed to satisfying these needs.

### BRIEF DESCRIPTION OF THE DRAWINGS

The foregoing and other advantages of the invention will become apparent upon reading the following detailed description and upon reference to the drawings in which:

FIG. 1 shows a single-zone packet-based communication system operable to utilize pre-established multicast groups according to the invention;

FIG. 2 shows a multi-zone packet-based communication system operable to utilize pre-established multicast groups according to the invention;

FIG. 3 is a flowchart showing steps of forming pre-establish multicast groups in advance of prospective calls according to the invention;

FIG. 4 is a flowchart showing steps of setting up calls utilizing pre-established multicast groups according to the invention;

FIG. 5 is a message sequence chart associated with a talkgroup call set up according to methods of the prior art; and

FIG. 6 is a message sequence chart associated with a talkgroup call set up using pre-established multicast groups according to the present invention.

### DESCRIPTION OF PREFERRED EMBODIMENTS

The following describes systems and methods for implementing dispatch and/or point-to-point calls using pre-established multicast groups in single-zone or multiple-zone architectures.

In one embodiment of the present invention, there is provided a method of setting up pre-established multicast group(s) in advance of prospective call(s). The method comprises identifying a plurality of endpoints (e.g., RF sites, console sites, call loggers and/or telephony interfaces, in the same or different zones) that are expected to collectively participate in a prospective call. Then, a payload multicast group address is identified that may be used for distributing payload between the endpoints upon initiation of the prospective call. The payload multicast group address is distributed to the endpoints, and the endpoints issue commands (e.g., IGMP Join commands) to one or more network devices, causing the network devices to establish a multicast routing tree between the endpoints. The multicast routing tree is established prior to the prospective call being initiated, such that the endpoints define a pre-established, semi-permanent multicast group having joined the multicast group address. Later, upon initiation of a call or calls, the pre-established multicast group is eligible to receive payload messages via the payload multicast group address.

Optionally, the pre-established multicast group may be torn down when a controller determines there is a reduced expectation that the endpoints will collectively participate in a prospective call. In such case, the controller instructs the endpoints to leave the multicast group. Upon receiving the messages, the endpoints issue commands (e.g., IGMP Leave commands) to one or more network devices, causing the network devices to prune their respective branches of the multicast routing tree.

In another embodiment of the present invention, there is provided a method of setting up a call using a pre-established multicast group. Upon a call request being received from a sourcing endpoint, recipient endpoint(s) are identified for the call, the sourcing and recipient endpoints thereby defining participating endpoints. If the participating endpoints are members of a pre-established multicast group, a call grant message is sent to at least the sourcing endpoint that includes the multicast group address associated with the pre-established multicast group. Thereafter, the sourcing endpoint sends, via one or more network devices, payload message(s) addressed to the multicast group address so that they may be received by the pre-established multicast group. Optionally, if the participating endpoints are not members of a pre-established multicast group, a multicast group is established for the duration of the call, using a multicast group address that differs from any of the pre-established multicast groups.

In yet another embodiment of the present invention, there is provided a communication system operable to implement calls using pre-established multicast group(s). The communication system includes a controller being operable to identify selected endpoints in one or more communication zones that are expected to participate in prospective call(s) (e.g., talkgroup calls), and to instruct the endpoints to join a multicast group address, thereby defining a pre-established multicast group. A packet network establishes a multicast routing tree between the selected endpoints prior to the prospective call(s) being initiated and, upon initiation of the call(s), distributes payload via the multicast routing tree to the pre-established multicast group.

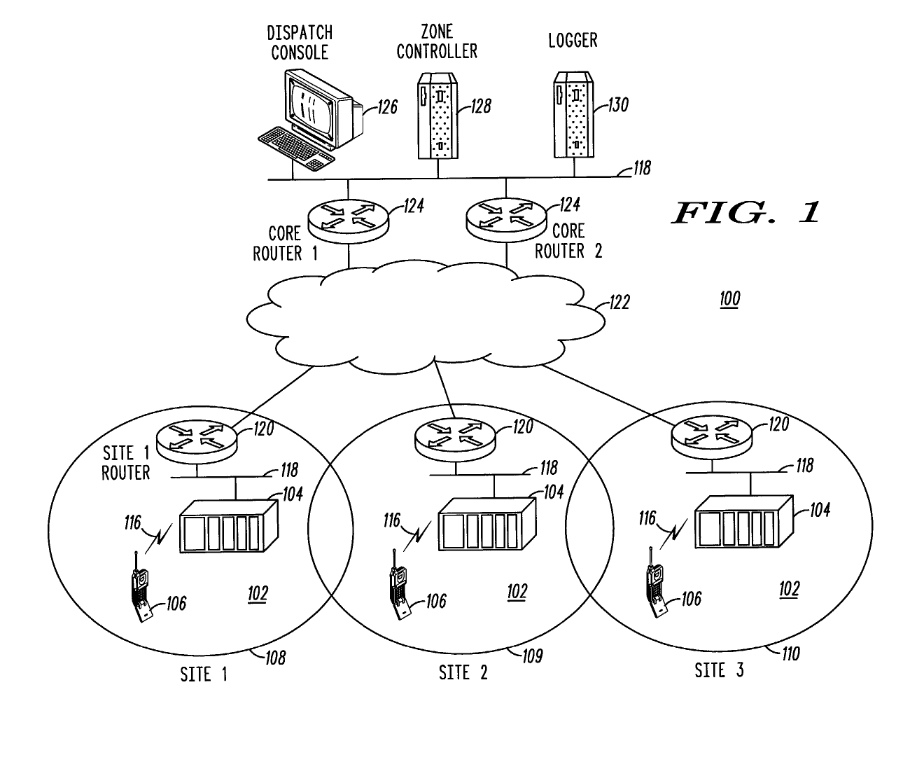

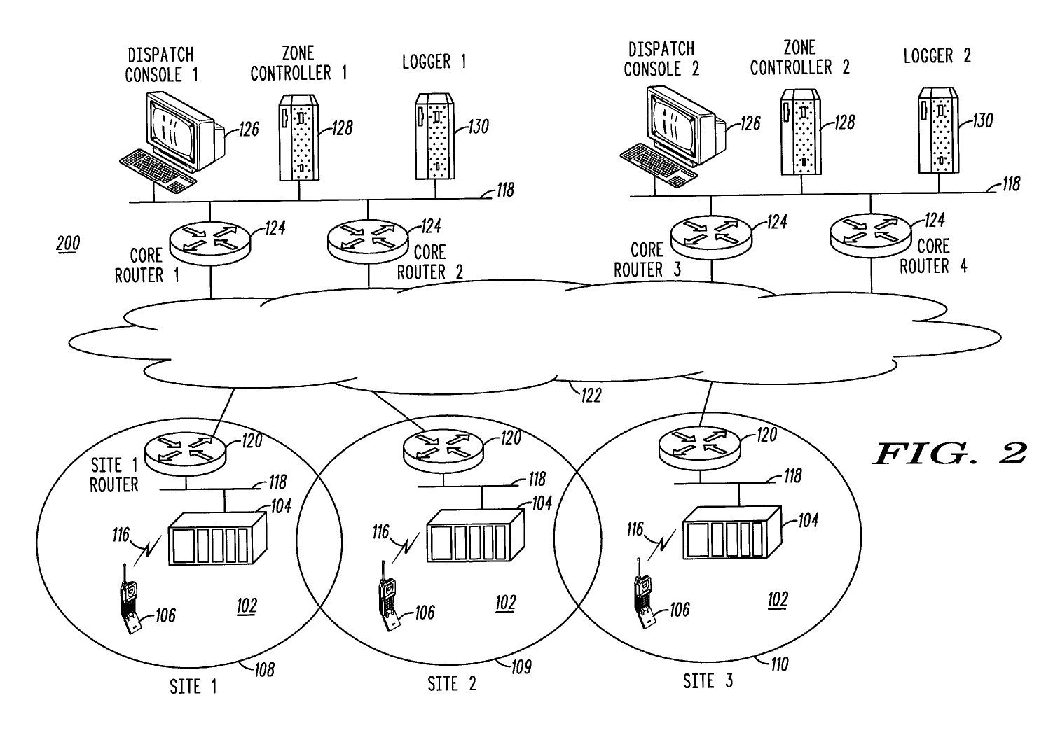

Turning now to the drawings and referring initially to FIG. 1 and FIG. 2, there is shown by way of examples and not limitation, packet-based communication systems 100 (FIG. 1) and 200 (FIG. 2) comprising a plurality of base sites 102 organized into one or more communication “zones.” For convenience, like reference numerals will be used for like elements in FIG. 1 and FIG. 2. As shown, communication system 100 comprises three base sites 102, denoted “Site 1,” “Site 2” and “Site 3” of a single zone. Communication system 200 comprises a plurality of base sites 102 in multiple zones (two shown). As shown, communication system 200 includes two base sites 102 of a first zone, denoted “Site 1” and “Site 2,” and a single base site 102 denoted “Site 3” of a second zone. As will be appreciated, the communication systems 100, 200 may include virtually any number of sites 102 and/or zones.

The base sites 102 include base stations 104 for communicating with wireless communication units 106 distributed among respective coverage areas 108-110 (FIG. 1) or 111-113 (FIG. 2) via wireless communication resources 116. Suitable wireless communication resources 116 are multiple RF (radio frequency) channels such as pairs of frequency carriers, time division multiple access (TDMA) slots, code division multiple access (CDMA) channels, or any other RF transmission media. The communication units 106 may be arranged into talk groups having corresponding talk group identifications as known in the art. The communication units 106 may roam from site to site, including sites in the same or different zones.

The base sites 102 are logically coupled, via respective local area networks (LANs) 118 to router elements 120 (“base site routers”). The LANs 118 may comprise, for example, Ethernet, Token Ring, Wireless LAN, or any other commercial or proprietary LAN technology. The base site routers 120, in turn, are logically coupled to router elements (not shown) of an IP network 122. The IP network 122 is similarly coupled to router elements 124 (“core routers”) that are linked, via LAN 118 to various infrastructure devices. As shown, the infrastructure devices of each zone include dispatch consoles 126 (one shown), a zone controller 128 and call logger 130. In FIG. 2, the infrastructure devices are denoted “Dispatch Console 1” and “Dispatch Console 2,” “Zone Controller 1” and “Zone Controller 2” and “Logger 1” and “Logger 2” to distinguish between the infrastructure devices of a first and second zone. The infrastructure devices may be located at an infrastructure site or distributed among the base sites and/or console sites.

The dispatch consoles 126 are devices that enable a user (typically referred to as a “dispatcher” or “dispatch operator”) to communicate with, and to monitor communications between communication units 106 and/or other infrastructure devices, as is known in the art. For example, the console 126 can affiliate with talkgroups for monitoring purposes, that is to receive payload (e.g., audio, video, data) being communicated on the talkgroups, or to source payload for the talkgroups.

The zone controllers 128 manage the provision of dispatch and telephone services for devices of the communication system 100 or 200. In so doing, the zone controller 128 performs a number of tasks, including tracking the location of the communication devices 106 as they move about the communication system 100 or 200 and assigning communication resources 117 for use by the communication devices. Further, according to principles of the present invention, the zone controller 128 manages and assigns IP multicast addresses for certain pre-established multicast groups that are established in advance of prospective calls. The zone controller may still further manage and assign IP multicast addresses on a call by call basis for certain multicast groups, as is known in the art. In the multi-zone system (FIG. 2), these tasks may be performed by a controlling zone controller (e.g., Zone Controller 1 or Zone Controller 2) or distributed among Zone Controller 1 and Zone Controller 2.

The call loggers 130 record packetized voice talkgroup, private calls and telephony calls in the communication system 100 or 200. The call logger 130 may also record data calls. A call logger device typically stores the voice payload in its native format (i.e. vocoded audio). When it is desirable to playback the voice conversation at a later time, the call logger retrieves and decodes all packets which bound the call in question.

As will be appreciated, the communication systems 100, 200 may include various other communication devices not shown in FIG. 1 or FIG. 2. These devices may reside at one or more infrastructure sites or may be distributed among base sites, console sites and/or infrastructure sites. These devices may include, but are not limited to site controller(s), comparator(s), scanner(s), IP telephony gateways, electronic mail gateways, paging gateways, game gateways and/or electronic commerce gateways. These devices are typically wireline devices, i.e., connected by wireline to the base site(s) or other infrastructure device(s) but may also be implemented as wireless devices. Generally, such communication devices may be either sources or recipients of payload and/or control messages routed through the systems 100 or 200. These devices are described briefly below:

A site controller is a device having a processor (such as a microprocessor, microcontroller, digital signal processor or combination of such devices) and a memory (such as volatile or non-volatile digital storage devices or combination of such devices), that may be located at a particular site. A site controller may be used to control the communication of payload and/or control messages between repeater(s) at a particular site. A site controller may also control communications between a base station 104 and its base site router 120. In one embodiment, for example, a site controller sends IGMP Leave and Join messages to a base site router 120 to enable the base station 104 at that site to receive payload and/or control messages addressed to particular multicast group address(es).

A comparator (or “voter”) is a device, usually connected by wireline to various receivers (e.g., different base stations or repeaters) receiving different instance(s) of a particular message or signal (e.g., from a wireless communication unit 106). The comparator receives and compares among the different instances of the signal that may be received by the different receivers, and produces an output message that is comprised of either an entire message from one of the receivers or a composite message comprised of segments of the message received from one or more of the receivers. Each message may be comprised of a plurality of message frames.

A scanner is a receiver that is adapted to monitor message transmissions from communication devices such as mobile or portable wireless radio units, consoles, repeaters, and the like. In one mode of operation, for example, a scanner scans the radio spectrum for the purpose of finding and, optionally, locking on to carrier frequencies containing message transmissions. Scanners are sometimes used by parties that are not intended recipients of the message transmissions and thus may or may not be members of a particular talkgroup for which the message transmissions are intended.

Generally, a gateway device is one that provides voice and control translation services between two dissimilar communication systems. Other services such as feature translation, authentication, authorization and encryption could also be provided by a gateway device. For example, an IP telephony gateway may convert IP control and/or audio packets from the communication system 100 or 200 into the format of a local public switched telephone network (PSTN), or vice versa, thereby allowing telephone conversations to take place between the communication devices 106 and telephones connected to the PSTN. Similarly, electronic mail gateways, paging gateways, game gateways and electronic commerce gateways might provide translation services from the communication system 100 or 200 to an electronic mail server, paging server, game server, and electronic commerce server, respectively.

The routers of the systems 100 and 200 (i.e., base site routers 120, core routers 124 and the routers (not shown) of the IP network 122) are functional elements that may be embodied in separate physical devices or combinations of such devices. Generally, the routers comprise specialized or general purpose network devices that are configured to receive IP packets from a particular host in the communication system 100 or 200 and relay the packets to other router(s) or host(s) in the communication system 100 or 200. The routers thereby define a packet network for routing packets between host devices of the communication system 100 or 200. As defined herein, host devices that are sources or recipients of IP packets representative of control or payload messages for a particular call (or prospective call) are “participating devices” for that call. The host devices may comprise routers, base stations 104, consoles 126, zone controllers 128, loggers 130 or generally any wireline device of the communication system 100 or 200. Recent advances in technology have also extended IP host functionality to wireless devices, in which case the wireless communication units 106 or other wireless devices may comprise host devices as defined herein. Each host device has a unique IP address. The host devices include respective processors (which may comprise, for example, microprocessors, microcontrollers, digital signal processors or combination of such devices) and memory (which may comprise, for example, volatile or non-volatile digital storage devices or combination of such devices).

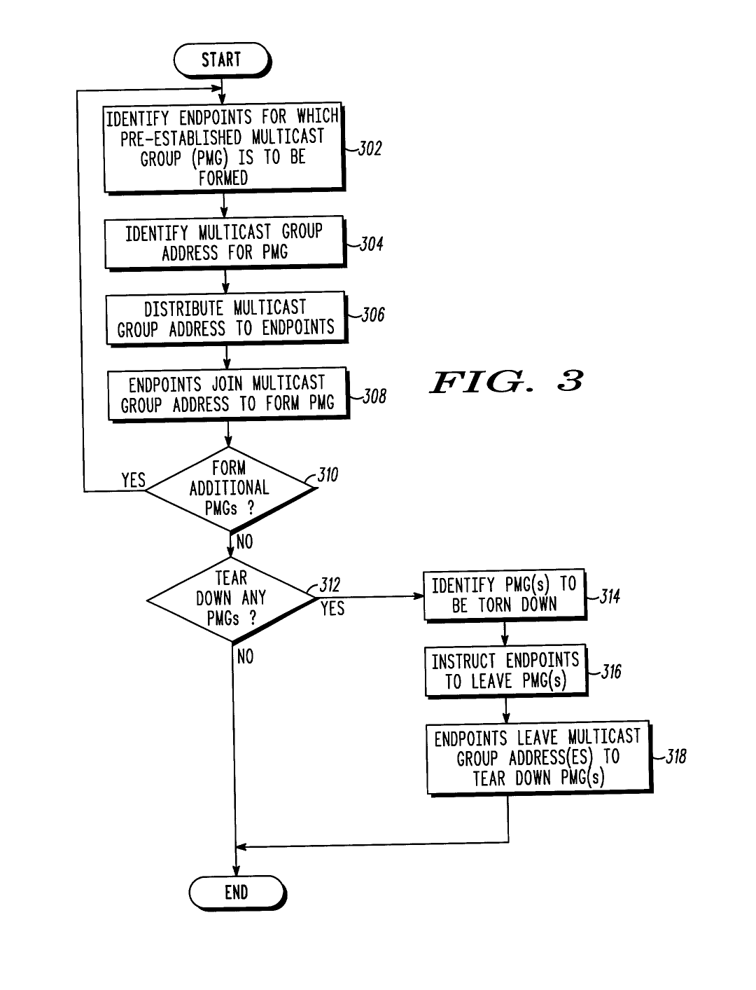

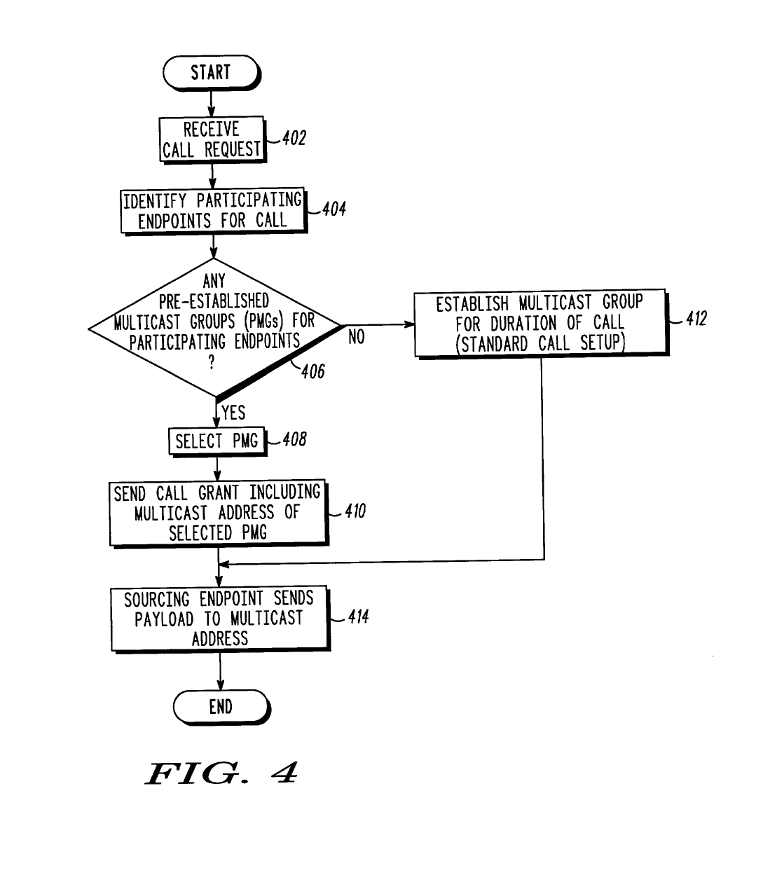

Packets are distributed between hosts from point-to-point using IP unicast routing protocols or from point-to-multipoint (i.e., to groups of hosts) using IP multicast routing protocols. As will be described in greater detail in relation to FIG. 3 and FIG. 4, the preferred embodiment of the present invention employs multicast routing trees that are pre-established and maintained semi-permanently in advance of calls for certain multicast groups such that when calls occur, call set-up times are reduced and voice quality is improved. Suitable multicast routing protocols may comprise sparse mode routing protocols such as the Core Based Tree (CBT) protocol or the Protocol Independent Multicast-Sparse Mode (PIM-SM) protocol, dense mode routing protocols such as the Distance Vector Multicast Routing Protocol (DVMRP), Protocol Independent Multicast-Dense Mode (PIM-DM) or the Multicast Open Shortest Path First (MOSPF) protocol.

FIG. 3 shows steps performed in setting up (and tearing down) pre-established multicast groups according to one embodiment of the invention. The steps of FIG. 3 are implemented using stored software routines within a controlling zone controller 128 and, where applicable, by endpoints and/or routers forming the network 100 or 200.

At step 302, the zone controller 128 identifies endpoints for which a pre-established multicast group is to be formed. The endpoints may comprise virtually any combination of IP host devices, including but not limited to RF sites (“base sites”), console sites, call loggers and/or other infrastructure devices in a single zone or distributed among multiple zones. Alternatively or additionally, the endpoints may include communication units 106 in instances where the communication units 106 are IP host devices. Advantageously, the endpoints will comprise groups of endpoints that form known, likely traffic configurations, i.e., endpoints that are expected to collectively participate in prospective call(s) on a relatively frequent basis. For example, those skilled in the art of trunked radio communication systems will appreciate that the vast majority of infrastructure traffic is sourced at a base site, and is destined for either the sourcing site or the sourcing site and one other adjacent site. Additionally, the traffic is often destined for a console site or a logging site. Accordingly, it is contemplated that pre-established multicast groups will be desired between different groups of geographically adjacent sites and, in many cases, will include a console, call logger as well. For example, with reference to FIG. 1, pre-established multicast group(s) might be established between Site 1 and Site 2, Site 2 and Site 3 and perhaps between Sites 1, 2 and 3 each of which may also include the dispatch console 126 and call logger 130. As has been stated, the endpoints may be distributed among multiple zones. For example, with reference to FIG. 2, a pre-established multicast group could be established between Site 2 and Site 3 and may further include Dispatch Console 1 and 2 and Call Logger 1 and 2.

At step 304, the zone controller 128 identifies a multicast group address that is to be used for the pre-established multicast group. In the preferred embodiment, the zone controller 128 dynamically assigns and manages multicast addresses for the pre-established multicast groups. That is, the zone controller has the flexibility to select from among a plurality of different multicast address to be used by different groups of endpoints. However, a multicast group address, once selected for a particular pre-established multicast group, is semi-permanently assigned to that group and not available to be assigned to other groups until such time, if at all, as the first group ceases using the assigned multicast address. Dynamic, rather than static assignment of addresses is advantageous in terms of efficient use of resources in the network. Alternatively, however, static assignment of addresses may be done whereby certain multicast addresses are reserved for certain groups of endpoints and not available for other groups if not used.

At step 306, the zone controller distributes the selected multicast group address to the endpoints. In one embodiment, the multicast group address is included in or accompanied by a message instructing the endpoints to join the multicast group address. At step 308, the endpoints send IGMP “Join” messages to their associated routers to signify their desire to join the assigned multicast address. Upon receiving the Join messages, the routers of the network create routing table entries to form a multicast routing tree spanning to the endpoints. The endpoints, having joined the assigned multicast address, thereby define a pre-established multicast group (i.e., formed prior to prospective call(s)) that is eligible to receive payload addressed to the payload multicast group address via the multicast routing tree, when prospective call(s) occur.

At step 310, the zone controller determines whether any additional multicast groups are to be pre-established. If so, the process returns to step 302 to identify endpoints, etc. of the additional groups. Generally, the process may be performed any number of times to form a corresponding number of pre-established multicast groups. Additional groups may also be set up dynamically during system operation, for example, if certain sets of endpoints initially not having a pre-established multicast group are found to have high incidents of calls.

If no further multicast groups are to be pre-established, the process proceeds to step 312 where the zone controller determines whether any multicast groups having been pre-established are to be torn down or disestablished. If so, the zone controller identifies at step 314 the pre-established groups that are to be torn down. The zone controller may wish to tear down a multicast group pre-established for a set of endpoints, for example, based on statistics that the call rate for the set of endpoints is lower than a certain threshold and therefore does not justify maintaining a pre-established multicast group. More generally, the zone controller may determine that a pre-established multicast group should be torn down in response to a reduced expectation that the endpoints will collectively participate in prospective call(s). In either case, the zone controller at step 316 instructs the endpoints to leave the pre-established multicast group. Then, at step 318, the endpoints send IGMP “Leave” messages to their associated routers to signify their desire to leave the assigned multicast address. Upon receiving the Leave messages, the routers of the network remove the appropriate interfaces so as to prune the branches of the routing tree formerly associated with the multicast group.

Now turning to FIG. 4, there will be described steps of setting up a call using pre-established multicast groups according to one embodiment of the invention. The steps of FIG. 4 are implemented using stored software routines within a controlling zone controller 128 and, where applicable, by endpoints and/or routers forming the network 100 or 200.

At step 402, the zone controller receives a call request from a sourcing endpoint comprising, for example, a base station, console or other infrastructure device (or wireless communication unit, if IP capable). Upon receiving the call request, the zone controller identifies at step 404 the participating endpoints for the call. Generally, the participating endpoints will include the sourcing endpoint and one or more recipient endpoints, comprising, likewise, a base station, console or other infrastructure device (or wireless communication unit, if IP capable). In the case of a talkgroup call, the participating devices comprise all of the device(s) affiliated with the talkgroup.

At step 406, the zone controller determines whether any pre-established multicast groups are available for use by the participating endpoints. If so, the zone controller selects one of the pre-established multicast groups at step 408. Of course, if only one is available, that group is selected at step 408. If multiple groups are available, the selection at step 408 may be accomplished by some predetermined criteria such as, for example, selecting the group that is least utilized. Most advantageously, in terms of efficient use of resources in the network, the group selected at step 408 will include exactly the participating endpoints for the call, but no more. For example, with reference to FIG. 1, suppose a first pre-established multicast group exists between Site 1 and Site 2 and a second multicast group exists between Sites 1, 2 and 3. Suppose further that the participating endpoints for the call identified at step 404 are Site 1 and Site 2. In such case, it is preferred that the first multicast group be selected at step 408 to support the call request because Site 1 and Site 2 are exactly the endpoints that will participate in the call. If efficient utilization of resources is not a concern, however, the second multicast group could be selected at step 408 but that would result in Site 3 receiving payload even though it is not an intended recipient of the call.

Having selected a pre-established multicast group for the call at step 408, the zone controller sends at step 410 call grant message(s) to the sourcing endpoint and, optionally, to the recipient endpoints that are to participate in the call. In a preferred embodiment, the call grant message includes the multicast group address of the selected pre-established multicast group. At step 414, the sourcing endpoint sends payload for the call to the indicated multicast address so that it will be routed to the endpoints of the pre-established multicast group having previously joined the multicast address.

At step 406, if a pre-established multicast group is not available for use by the participating endpoints, the method proceeds to step 412 wherein a multicast group is established for the duration of the call. The establishment of a multicast group on a call by call basis may be accomplished substantially as known in the art, by identifying a multicast group address and sending the multicast group address to the participating endpoints in a call grant message, whereby the endpoints join the multicast group address for the duration of the call and leave the multicast group address upon termination of the call. Then, at step 414, the sourcing endpoint sends payload for the call to the indicated multicast address so that it will be routed to the endpoints having joined the multicast address. In the preferred embodiment, multicast group addresses assigned on a call by call basis differ from the multicast groups of any of the pre-established multicast groups.

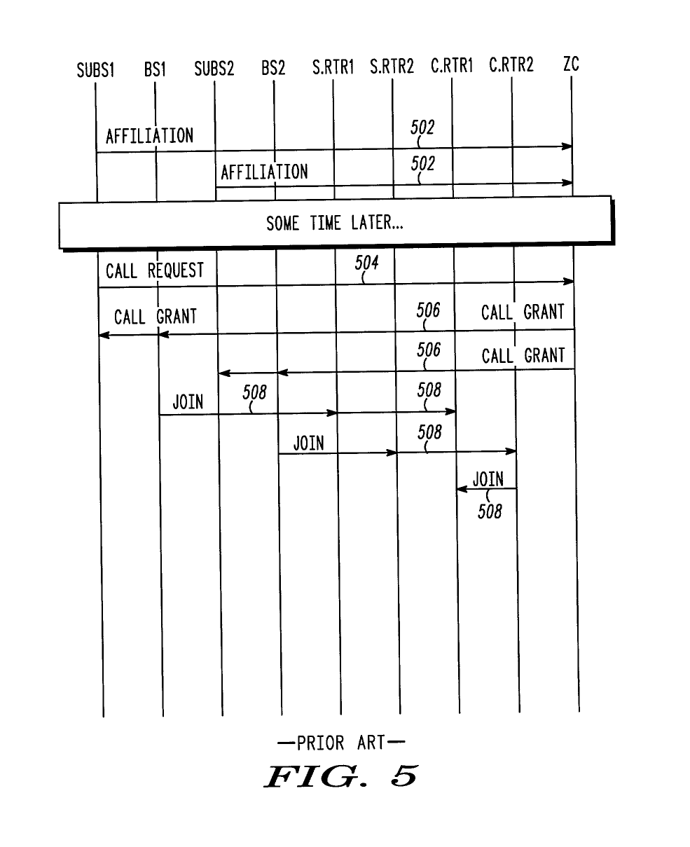

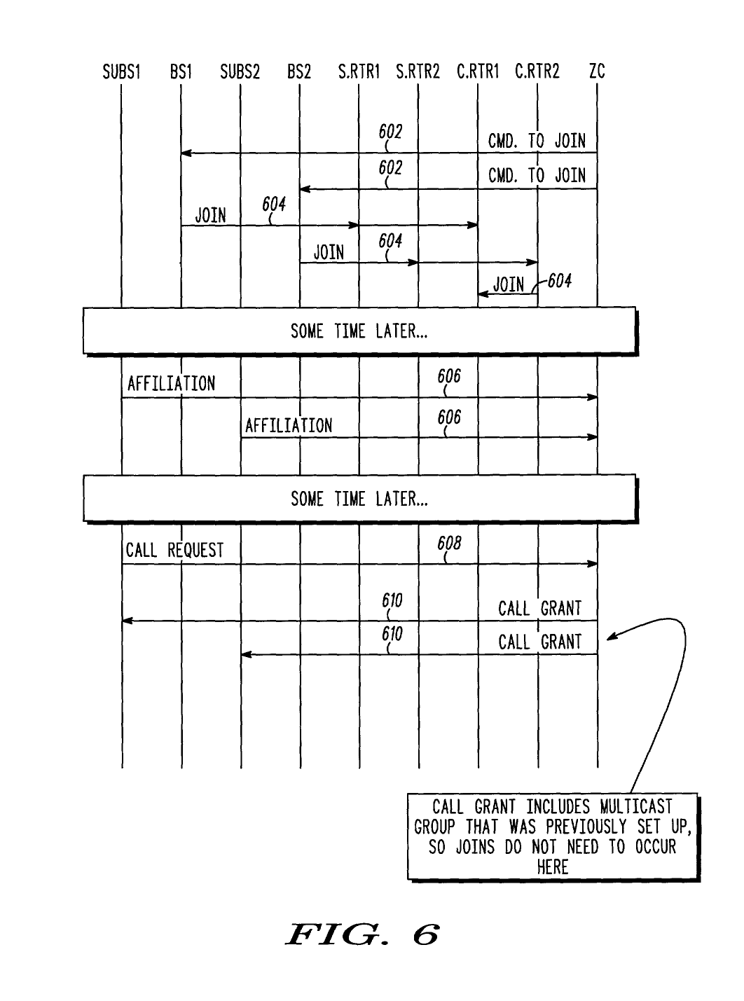

FIG. 5 and FIG. 6 are message sequence charts useful for illustrating advantages of the present invention. FIG. 5 depicts a message sequence associated with a talkgroup call set up according to methods of the prior art; and FIG. 6 shows the message sequence associated with a talkgroup call set up according to the present invention.

In the prior art (FIG. 5), a subscriber (“Subs1”) and a base station (“BS1”) of a first site send affiliation request messages 502 to a zone controller (“ZC”), indicating their desire to affiliate with a particular talkgroup. This is typically performed upon power up (or, in the example of a mobile or portable device, when the device roams between sites). Upon receiving the affiliation request, the zone controller typically returns an affiliation acknowledge (“ACK”) message (not shown) including a control multicast group address and the device(s) join the control multicast group address to receive control messages from the zone controller.

Some time later, upon receiving a call request (504) from the subscriber, the zone controller returns call grant messages 506 to participating devices for the call (as shown, to Subs1, BS1, and a subscriber (“Subs2”) and a base station (“BS2”) of a second site. The call grant messages include a payload multicast address. The participating devices join the payload multicast address, via Join messages 508 to attached routers. Upon receiving the “Join” messages, the routers of the network create routing table entries to form the spanning tree between the participating devices of the talkgroup. The participating devices leave the payload multicast address (Leave message not shown) and the spanning tree is pruned upon termination of the call.

In the present invention (FIG. 6), multicast groups are established in advance of prospective calls to reduce the number of Joins and Leaves, thereby reducing call set up times and network traffic that would otherwise occur on a call by call basis. In “Cmd to Join” message 602, the zone controller commands selected endpoints that are to be in a pre-established multicast group to join a payload multicast group address. The endpoints join the payload multicast address, via Join messages 604 to attached routers. Upon receiving the “Join” messages, the routers of the network create routing table entries to form the spanning tree between the endpoints of the talkgroup. The endpoints, having joined the assigned multicast address, thereby define a pre-established multicast group (i.e., formed prior to prospective call(s)) that is eligible to receive payload addressed to the payload multicast group address via the multicast routing tree, when prospective call(s) occur.

Some time later, a subscriber (“Subs1”) and a base station (“BS1”) of a first site send affiliation request messages 606 to a zone controller (“ZC”), indicating their desire to affiliate with a particular talkgroup. Upon receiving the affiliation request, the zone controller returns an affiliation acknowledge (“ACK”) message (not shown) including a control multicast group address and the device(s) join the control multicast group address to receive control messages from the zone controller. The affiliation of devices with a talkgroup in the present invention accomplished in generally the same manner as the prior art, except that it may accomplished after pre-established multicast groups have been formed.

Some time later, upon receiving a call request (608) from the subscriber, the zone controller returns call grant messages 610 to participating devices for the call (as shown, to Subs1, Subs2). The call grant messages include the payload multicast address of the pre-established multicast group for which the multicast spanning tree has already been formed. Thus, there is no need for additional Joins and the call is set up much more quickly than heretofore possible. Typically, when the call is concluded, the endpoints do not leave the pre-established multicast group, and the spanning tree remains intact to support further calls.

The present disclosure therefore has identified various methods for implementing calls using pre-established multicast groups in single-zone and multiple-zone architectures. The methods provide for efficient use of communication resources, through reduction of Join and Leave messages that would otherwise be required on a call by call basis for transmission of payload messages.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising the steps of:
identifying a plurality of endpoints for which a pre-established multicast group is to be formed;
identifying, prior to initiation of a prospective call, a multicast group address usable for distributing payload between the endpoints upon initiation of the prospective call;
distributing the multicast group address to the endpoints;
issuing, by the endpoints, respective commands to one or more network devices, thereby forming, prior to the prospective call being initiated, a multicast routing tree branching to the endpoints, the endpoints thereby defining a pre-established multicast group.

2. The method of claim 1, wherein the step of identifying a plurality of endpoints comprises identifying endpoints that are expected to collectively participate in the prospective call.

3. The method of claim 1, wherein the endpoints are selected from the group consisting of radio frequency (RF) sites, console sites, call loggers, telephony interfaces in a single communication zone.

4. The method of claim 3, wherein the step of identifying a plurality of endpoints comprises identifying two or more RF sites that are determined to be likely participants in the prospective call.

5. The method of claim 4, wherein the step of identifying two or more RF sites comprises identifying two or more adjacent RF sites as endpoints for the prospective call.

6. The method of claim 1, wherein the step of issuing commands comprises, sending, from the endpoints, IGMP Join messages to one or more local network devices.

7. The method of claim 1, performed a number of times to form a corresponding number of pre-established multicast groups.

8. The method of claim 7, further comprising the steps of:
determining, by a controller, that a first pre-established multicast group of the number of pre-established multicast groups should be torn down;
sending, from the controller to the endpoints of the first pre-established multicast group, respective messages instructing the endpoints to leave the first pre-established multicast group;
receiving, by the endpoints, the messages; and
issuing, by the endpoints, respective commands to one or more network devices to prune their respective branches of the multicast routing tree associated with the first pre-established multicast group.

9. The method of claim 8 wherein the step of determining is accomplished in response to a reduced expectation for the endpoints of the first pre-established multicast group to collectively participate in a prospective call.

10. The method of claim 8, wherein the step of issuing commands comprises, sending, from the endpoints, IGMP Leave messages to one or more local network devices.

11. The method of claim 1, wherein the endpoints are selected from the group consisting of radio frequency (RF) sites, console sites, call loggers, telephony interfaces distributed among multiple communication zones.

12. The method of claim 11, wherein the step of identifying a plurality of endpoints comprises identifying at least two RF sites in different communication zones that are determined to be likely participants in the prospective call.

13. The method of claim 12, wherein the step of identifying at least two RF sites comprises identifying two or more adjacent RF sites as endpoints for the prospective call.

14. A method comprising the steps of:
receiving, from a sourcing endpoint, a call request;
identifying a plurality of participating endpoints for the call, the participating endpoints including the sourcing endpoint and one or more recipient endpoints;
determining whether any pre-established multicast groups are available for use by the participating endpoints;
if a pre-established multicast group is available for use by the participating endpoints,
(1) sending, to at least the sourcing endpoint, a call grant message including a multicast group address associated with the pre-established multicast group; and
(2) sending, from the sourcing endpoint to the pre-established multicast group, via one or more network devices, at least one payload message addressed to the multicast group address associated with the pre-established multicast group.

15. The method of claim 14, wherein the step of determining comprises determining that two or more pre-established multicast groups are available for use by the participating endpoints, the method comprising:
selecting one of the two or more pre-established multicast groups to be used by the participating endpoints, thereby defining a selected pre-established multicast group;
sending, to at least the sourcing endpoint, a call grant message including a multicast group address associated with the selected pre-established multicast group; and
sending, from the sourcing endpoint to the selected pre-established multicast group, via one or more network devices, at least one payload message addressed to the multicast group address of the selected pre-established multicast group.

16. The method of claim 15, wherein the step of selecting comprises selecting one of the two or more pre-established multicast groups that is least utilized.

17. The method of claim 14 wherein, if a pre-established multicast group is not available for use by the participating endpoints, the method comprises:
establishing a multicast group for a duration of the call, the multicast group having an associated multicast group address that differs from any of the pre-established multicast groups; and
sending, from the sourcing endpoint to the multicast group address for the call, via one or more network devices, at least one payload message addressed to the multicast group address for the call.

18. The method of claim 17 wherein the step of establishing a multicast group for the duration of the call comprises:
identifying the multicast group address to be used for the call;
distributing the multicast group address to the participating endpoints; and
joining, by the participating endpoints, the multicast group address, thereby forming, subsequent to initiation of the call, a multicast routing tree branching to the endpoints for at least the duration of the call.

19. A communication system comprising:
one or more communication zones;
a controller operable to identify selected endpoints distributed among the one or more communication zones that are expected to participate in a prospective call, and to instruct the selected endpoints to join a multicast group address, thereby forming a pre-established multicast group;
a packet network for establishing, prior to the prospective call being initiated, a multicast routing tree between the selected endpoints and for distributing payload, via the multicast routing tree, to the selected endpoints upon initiation of the prospective call.

20. The communication system of claim 19, wherein the controller is operable to define a talkgroup comprising the selected endpoints.
